(19) United States
(12) Patent Application Publication
(10) Pub. No.: US 2002/0060440 A1
(43) Pub. Date: May 23, 2002

(54) Exteriorly mountable vehicle step

(76) Inventor: Ron D. Storer, Villa Park, CA (US)

Correspondence Address: KIT M. STETINA, STETINA BRUNDA GARRED & BRUCKER, SUITE 250, 75 ENTERPRISE, ALISO VIEJO, CA, 92656, US

(21) Appl. No.: 09/864,589

(22) Filed: May 24, 2001

Related U.S. Application Data
(63) Continuation-in-part of application No. 29/132,894, filed on Nov. 17, 2000.

(51) Int. Cl. B60R 3/00

(52) U.S. Cl. 280/163

(57) ABSTRACT

A step for engagement with a conventional towing receiver hitch affixed to a vehicle. The step includes a support component upon which to stand and a coupler component for engaging the support component with the receiver hitch. Preferably, the support component is a generally cylindrical rung, while the coupler component is integral with and extends from a substantially central location of the support component.

### CROSS-REFERENCE TO RELATED APPLICATIONS

This application is a continuation-in-part of co-pending U.S. patent application Ser. No. 29/132,894, filed Nov. 17, 2000.

### STATEMENT RE: FEDERALLY SPONSORED RESEARCH/DEVELOPMENT (Not Applicable)

### BACKGROUND OF THE INVENTION

The present invention relates in general to vehicle accessories, and in particular to a step for releasable engagement with a trailer-type receiver hitch protruding from a vehicle, said step including a support component upon which a user can stand to enhance reachability of a roof or window surface of the vehicle.

Vehicle accessorization is a common development as vehicle owners seek to customize cars or trucks so that they meet certain needs or requirements. Thus, for example, devices for protecting tail lights, head lights, grills, side panels, and the like are available for installation on vehicles. Large motor homes lend themselves to additional accessories such as ladders, air conditioner mounts, roof racks, and other paraphanalia. Finally, many vehicles are equipped with receiver hitches to which can be attached house, boat, moving, and other types of trailers.

Of special interest is the receiver hitch accessory in that it typically is not engaged with a trailer and therefore really provides no useful purpose most of the time. Nonetheless, it is ever present as it projects, sometimes unsafely, from the rear of a vehicle. Unrelatedly, owners and drivers of many vehicles, such as sport utility vehicles and motor homes, could greatly benefit from better access to roof racks and roof surfaces, rear windows, and other hard-to-reach areas. As a result, a primary object of the present invention is to provide a step and a step assembly wherein a support component is engageable with a receiver hitch to thereby permit a user to stand on the support component and increase reach distance.

Additionally, such sport utility vehicles and/or motorhomes typically include polymer molded rear bumpers which are highly vulnerable to impact damage and extremely expensive to repair and/or replace. As such, it is another object of the present invention to provide a bumper protection device which can be easily replaced upon encountering a minor impact/collision to avoid more costly damage to the vehicle bumper.

Another object of the present invention is to provide a step and a step assembly wherein the support component has integral therewith a coupler component for releasably engaging a conventional receiver hitch.

Yet another object of the present invention is to provide a step and a step assembly wherein the step assembly is adjustably mounted to a receiver hitch and includes an anti-rattle locking system to reduce rattling of the step assembly within the receiver hitch.

These and other objects of the present invention will become apparent throughout the description thereof which now follows.

### BRIEF SUMMARY OF THE INVENTION

The present invention is a step for engagement with a conventional receiver hitch affixed to a vehicle. The step includes a support component upon which a user may stand and a coupler component for releasably mounting the support component upon the receiver hitch. Preferably, the support component is a generally cylindrical rung, while the coupler component is formed integral with the support component and extends generally perpendicularly outward from a substantially central location of the support component.

The coupler component comprises a square shaped tongue having a complimentary configuration to the conventional receiver hitch on a vehicle such that a coupler may be slidably inserted within the receiver hitch. The coupler additionally includes multiple apertures which may be axially aligned with the hitch pin aperture formed in the conventional receiver hitch such that the step may be adjusted relative the receiver hitch to be utilized on all vehicles. The step is releasably mounted to the receiver hitch by way of a conventional hitch pin.

The step of the present invention additionally includes an anti-rattle locking mechanism which is threadedly connected to the lower portion of the step to selectively engage the step as well as the receiver hitch. The locking system constantly biases the step against the receiver hitch thereby eliminating relative movement and rattling between the step and receiver hitch during vehicle operation.

These as well as other features of the present invention will become more apparent upon referenced to the drawings.

### BRIEF DESCRIPTION OF THE DRAWINGS

An illustrative and presently preferred embodiment of the invention is shown in the accompanying drawings in which:

FIG. 1 is a perspective view of step engaged with a conventional receiver hitch affixed to a vehicle;

FIG. 2 is a perspective view of the step of FIG. 1 alone;

FIG. 3 is a top plan view of the step of FIG. 2;

FIG. 4 is a rear elevation view of the step of FIG. 2; and

FIG. 5 is an end elevation view of the step of FIG. 2 and illustrating its anti-rattling locking system.

### DETAILED DESCRIPTION OF THE INVENTION

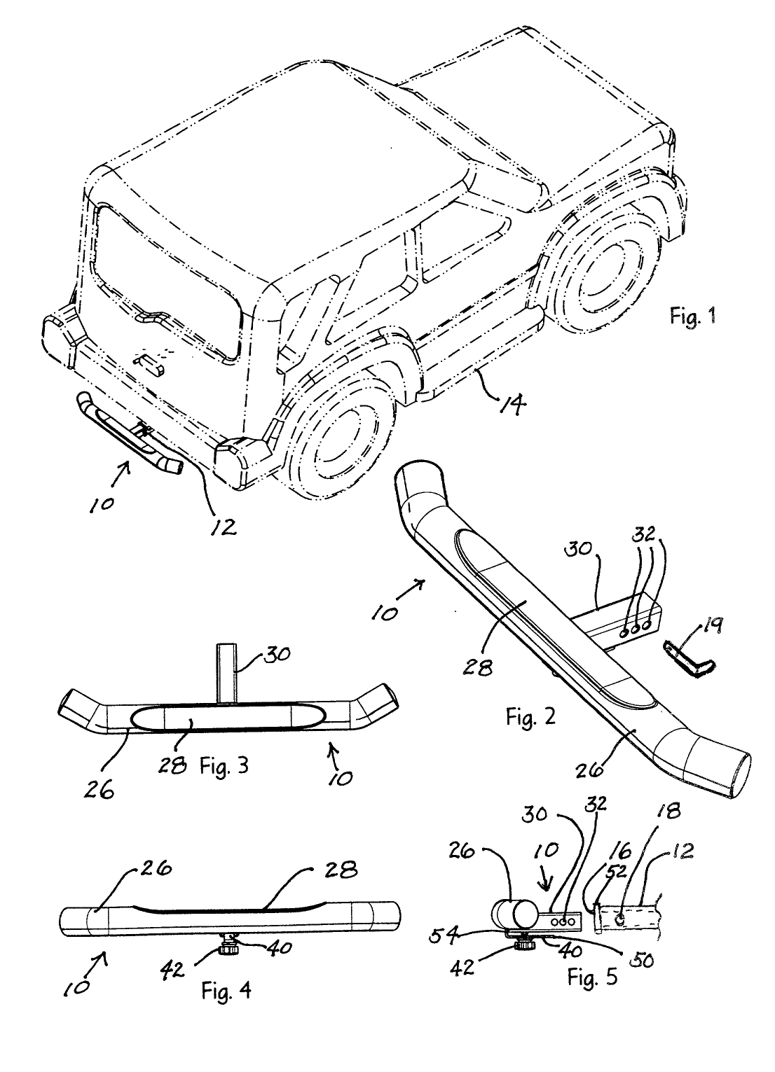

Referring to the figures, the exteriorly mountable vehicle step 10 of the present invention is depicted. As will be recognized, the step 10 is releasably mounted to a conventional receiver tow hitch 12 (shown in FIGS. 1 and 5) which is rigidly attached to the frame or chassis of a motor vehicle 14. As is well known, the receiver hitch 12 is formed having a square or rectangular axial opening 16 (shown in FIG. 5) and a hitch pin aperture 18. The opening 16 is sized to receive a conventional trailer hitch (not shown) which is selectively mounted to the receiver hitch 12 via a hitch pin 19 (shown in FIG. 2) which is extended through the hitch pin aperture 18 and into the trailer hitch (not shown). The step 10 of the present invention is adapted to be mounted to the receiver hitch 12 in an analogous fashion.

The step 10 includes a support component 26 which, in the preferred embodiment, comprises a rung upon which a user can stand and which preferably includes a generally flat central portion 28 for firm footing. In the preferred embodiment, the support component 26 is formed of a tubular metal material which can be chrome plated, painted or coated as desired. A coupler component 30 is rigidly attached for instance by a weld to the support component 26 and extends perpendicularly outwardly therefrom. The coupler component 30 is formed having a generally rectangular cross sectional configuration which is complimentary to and is sized to be received within the aperture opening 16 formed within the conventional receiver hitch 12. The coupler component 30 includes a plurality of apertures 32 formed therein, the diameter of which is sized to receive the conventional hitch pin 19 therein.

As best shown in FIGS. 4 and 5, the lower surface of the support component 26 may include an L-shaped locking member 40 which is selectively mounted to the under surface via a threaded fastener such as a threaded knob 42. By turning the knob 42, the locking member 40 is moved toward or away from the under surface of the support member 26. In the preferred embodiment, the locking member 40 is formed of metal but coated with a polymer material.

With the structure defined, the mounting and operation of the step 10 of the present invention may be described. As best shown in FIG. 5, the coupler component 30 of the step 10 is aligned with the opening 16 of the receiver hitch 12 and the support component 30 may then be axially positioned, i.e., slidably received within the aperture 16 of the receiver hitch 12. One of the apertures 32 formed on the coupler component 30 is aligned with the hitch pin aperture 18 formed in the receiver hitch 12. As will be recognized, due to the coupler component 30 having plural apertures 32 formed therein, the step 10 may be adjusted relative the bumper of the vehicle 14 by aligning a desired aperture 32 with the aperture 18 formed in the receiver hitch 12. When aligned, a conventional hitch pin 19 (shown in FIG. 2) may be extended through the aperture 18 and selected aperture 32 to lock the step 10 in a desired position upon the receiver hitch 12.

Subsequently, the threaded knob 42 can be loosened to allow the distal end 50 of the locking member 40 to be positioned to extend over the enlarged end flange 52 formed on the conventional receiver hitch 12. In this position, the proximal end 54 of the locking member 40 extends vertically upward to contact the support member 26; and upon tightening of the threaded knob 42, tightly engages the under surface of the support member 26. Upon continued tightening of the threaded knob 42, the distal end 50 of the locking member 40 tightly engages the end flange 52 of the receiver hitch 12 while the proximal end 54 tightly engages the under surface of the support component 26. Continued tightening of the threaded knob 42 causes a continual spring or biasing force to be applied to the locking member 40 which serves to eliminate relative movement or rattling of the step 10 relative the receiver hitch 12.

When mounted upon the vehicle 14, the step 10 provides an easy and convenient platform to allow easy access to roof racks or truck beds or the like of a vehicle. Further, the step 10 offers additional protection to vulnerable molded bumpers and the like of the vehicle 14 whereby during moderate impact, the vehicle bumper will be protected.

1. A step for engagement with a receiver hitch affixed to a vehicle, the step comprising:
a) a support component upon which to stand; and
b) a coupler component for engaging the support component with the receiver hitch.

2. A step as claimed in claim 1 wherein the support component is a generally cylindrical rung.

3. A step as claimed in claim 2 wherein the rung includes a generally flat central top portion.

4. A step as claimed in claim 1 wherein the coupler component is integrally formed with the support component.

5. A step as claimed in claim 4 wherein the coupler component extends perpendicularly outward from a substantially central location of the support component.

6. A step as claimed in claim 1 wherein the coupler component includes means for adjusting the position of the step relative the receiver hitch.

7. A step as claimed in claim 6 further comprising an exteriorly accessible locking member for maintaining the step tightly against the receiver hitch in a non-rattle interconnection.
